(19) United States
(12) Patent Application Publication
(10) Pub. No.: US 2026/0180241 A1
(43) Pub. Date: Jun. 25, 2026

(54) CONNECTOR ASSEMBLY HAVING ELECTRICAL CONNECTOR INSTALLED PARALLEL TO CIRCUIT BOARD AND METHOD OF INSTALLING THE SAME

(71) Applicant: DONGGUAN LUXSHARE TECHNOLOGIES CO., LTD, Dongguan City (CN)

(72) Inventors: Tengfang XIONG, Dongguan City (CN); Hengshan CHENG, Dongguan City (CN)

(73) Assignee: DONGGUAN LUXSHARE TECHNOLOGIES CO., LTD, Dongguan City (CN)

(21) Appl. No.: 19/331,151

(22) Filed: Sep. 17, 2025

Related U.S. Application Data
(63) Continuation-in-part of application No. 19/302,381, filed on Aug. 18, 2025.

(30) Foreign Application Priority Data
Dec. 23, 2024 (CN) 202411908063.7
May 22, 2025 (CN) 202521029926.3

(51) Int. Cl. H01R 13/533; H01R 12/71

(52) U.S. Cl. CPC H01R 13/533; H01R 12/716

(57) ABSTRACT

A connector assembly includes a mounting bracket, a cover, a heat sink, and an electrical connector. The mounting bracket is configured to be mounted to a circuit board. The mounting bracket includes a receiving space. The cover is rotatably assembled to the mounting bracket. The heat sink is disposed on a side of the mounting bracket. The receiving space is located between the mounting bracket and the heat sink. The electrical connector is mounted sideward into the receiving space. Besides, a method of installing the connector assembly is also disclosed.

### CROSS-REFERENCE TO RELATED APPLICATIONS

This patent application is a continuation-in-part of co-pending application Ser. No. Ser. No. 19/302,381, filed on Aug. 18, 2025 and titled “CONNECTOR ASSEMBLY HAVING ELECTRICAL CONNECTOR INSTALLED PARALLEL TO FIRST CIRCUIT BOARD AND METHOD OF INSTALLING THE SAME”, and further claims priority of a Chinese Patent Application No. 202521029926.3, filed on May 22, 2025 and titled “CONNECTOR ASSEMBLY”. The co-pending application Ser. No. 19/302,381 claims priority of a Chinese Patent Application No. 202411908063.7, filed on Dec. 23, 2024 and titled “CONNECTOR ASSEMBLY AND METHOD OF INSTALLING THE SAME”. The entire contents of all are hereby incorporated by reference.

### TECHNICAL FIELD

The present disclosure relates to a connector assembly and a method of installing the same, which belongs to the technical field of connectors.

### BACKGROUND

A connector assembly in the related art includes a mounting bracket mounted on a circuit board, an electrical connector at least partially received in the mounting bracket, and a retaining plate for retaining the electrical connector in the mounting bracket. The mounting bracket is usually provided with a receiving space extending along a first direction (for example, a vertical direction). The electrical connector is installed in the receiving space along the first direction. The retaining plate is installed on the electrical connector along the first direction. Finally, the retaining plate is fixed to the mounting bracket along the first direction through a fastener (for example, a screw).

It is understandable to those skilled in the art that the above installing method in the related art requires utilizing the space in the first direction. Under some boundary conditions, when there is not enough space in the first direction to install the electrical connector and the fastener, it is necessary to improve the connector assembly and the installing method in the related art.

### SUMMARY

An embodiment of the present disclosure adopts the following technical solution: a connector assembly including: a mounting bracket configured to be mounted to a circuit board, and the mounting bracket defining a receiving space; a cover rotatably assembled to the mounting bracket; a heat sink disposed on a side of the mounting bracket, and the receiving space being located between the mounting bracket and the heat sink; and an electrical connector installed into the receiving space along a lateral direction.

An embodiment of the present disclosure adopts the following technical solution: a method of installing a connector assembly, the connector assembly including: a mounting bracket defining a mounting space and a receiving space disposed adjacent to the mounting space along a first direction; a conductive film including an elastomer and a plurality of transfer conductive elements secured in the elastomer; the transfer conductive elements being configured to be electrically connected to a first circuit board; a cover rotatably assembled to the mounting bracket; the cover being located at one end of the receiving space along the first direction; a heat sink disposed on a side of the mounting bracket, and the receiving space being located between the mounting bracket and the heat sink; an electrical connector at least partially installed in the receiving space along a second direction perpendicular to the first direction; the electrical connector including a plurality of conductive terminals which are in contact with the transfer conductive elements; and a first fastener fixing the cover to the mounting bracket so that the cover presses against the electrical connector along the first direction; the method including:
installing the conductive film in the mounting space of the mounting bracket along the first direction;
installing the mounting bracket to the first circuit board or a second circuit board;
installing the cover to the mounting bracket;
installing the heat sink to the second circuit board;
installing the electrical connector at least partially into the receiving space of the mounting bracket along the second direction substantially parallel to the first circuit board; and
passing the first fastener through the cover and fixing the first fastener to the mounting bracket; the cover pressing against the electrical connector along the first direction, so that the plurality of conductive terminals of the electrical connector are electrically connected to the first circuit board through the transfer conductive elements.

### BRIEF DESCRIPTION OF DRAWINGS

FIG. 1 is a schematic perspective view of a connector assembly in accordance with an embodiment of the present disclosure;

FIG. 2 is a partial enlarged view of frame part B in FIG. 1;

FIG. 3 is a partially exploded perspective view of FIG. 1, in which a shield is separated;

FIG. 4 is a further perspective exploded view after removing the shield in FIG. 3;

FIG. 5 is a further partially exploded perspective view of FIG. 4;

FIG. 6 is a partially exploded perspective view of FIG. 5 from another angle;

FIG. 7 is a partial enlarged view of circled part C in FIG. 5;

FIG. 8 is a partial enlarged view of circled part D in FIG. 6;

FIG. 9 is a further partially exploded perspective view of FIG. 5;

FIG. 10 is an exploded perspective view of a cover and elastic components in FIG. 9;

FIG. 11 is an exploded perspective view of FIG. 10 from another angle;

FIG. 12 is an exploded perspective view of a conductive film, a mounting bracket, a first fixing component, a first circuit board and a protective frame;

FIG. 13 is a partial enlarged view of frame part E in FIG. 12;

FIG. 14 is an exploded perspective view of FIG. 12 from another angle;

FIG. 15 is a partially exploded perspective view of the conductive film in FIG. 12;

FIG. 16 is a partially exploded perspective view of an electrical connector;

FIG. 17 is a partially exploded perspective view of FIG. 16 from another angle;

FIG. 18 is a partially exploded perspective view of a set of cable modules in FIG. 16;

FIG. 19 is a partially exploded perspective view of FIG. 18 from another angle;

FIG. 20 is a schematic cross-sectional view taken along line F-F in FIG. 1, in which the cover is in an inclined open state, the electrical connector has just been installed into the mounting bracket, and a first fastener and a second fastener are in a state before being fastened;

FIG. 21 is a schematic cross-sectional view of another state in FIG. 20, in which the first fastener and the second fastener are in a fastened state, and at this time the cover is in a position of pressing against the electrical connector; and

FIG. 22 is a schematic cross-sectional view taken along line H-H in FIG. 1, in which the first fastener and the second fastener are both fastened in place;

FIG. 23 is a perspective schematic view of the connector assembly in accordance with another embodiment of the present disclosure;

FIG. 24 is a top view of FIG. 23;

FIG. 25 is a partially exploded view of FIG. 23;

FIG. 26 is a partially exploded view of FIG. 25 from another angle;

FIG. 27 is a perspective schematic view of a cover plate in FIG. 25;

FIG. 28 is a perspective schematic view of FIG. 27 from another angle;

FIG. 29 is a perspective exploded view of FIG. 27;

FIG. 30 is a perspective exploded view of FIG. 29 from another angle; and

FIG. 31 is a cross-sectional view taken along line J-J in FIG. 24.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

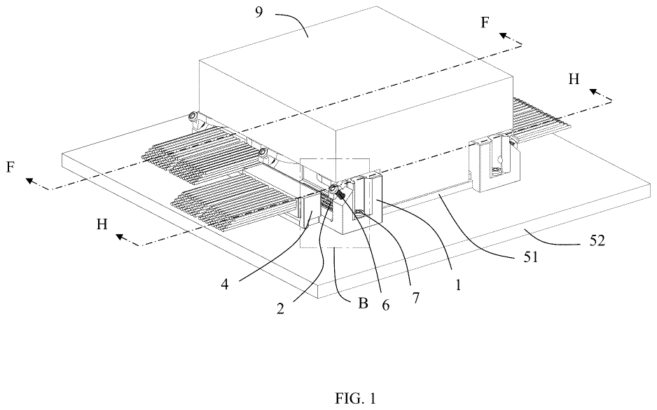

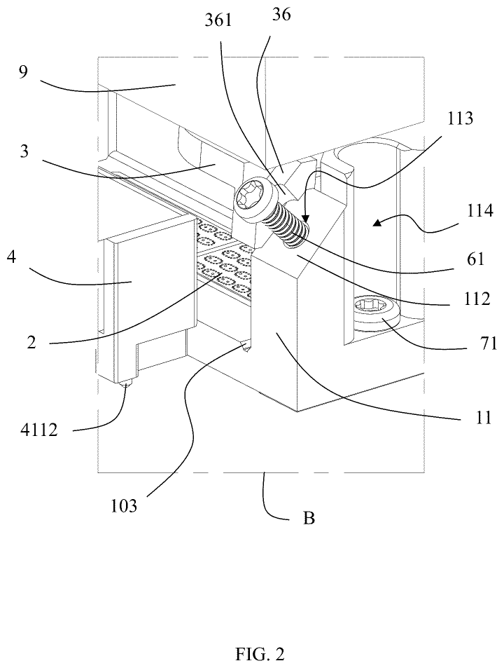

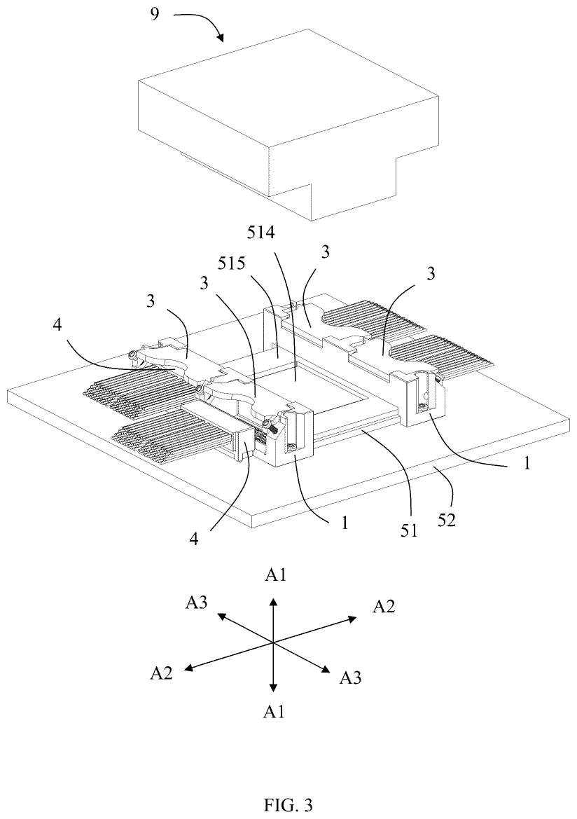

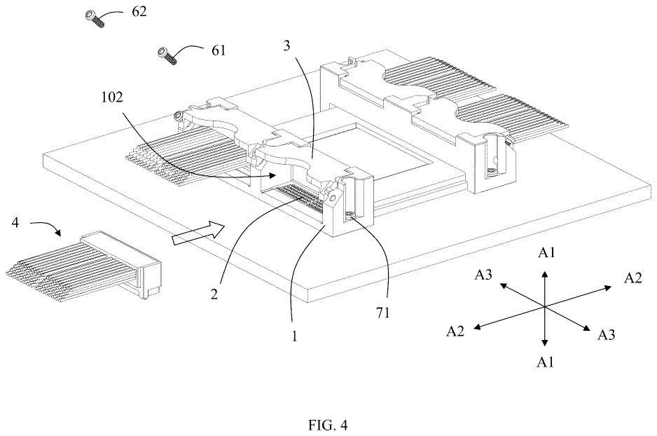

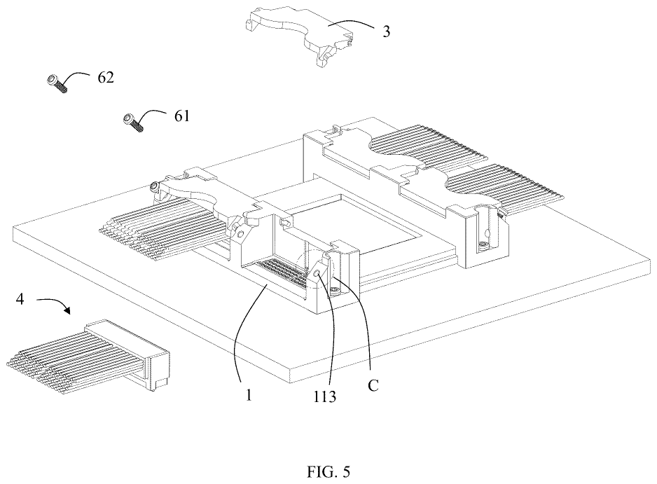

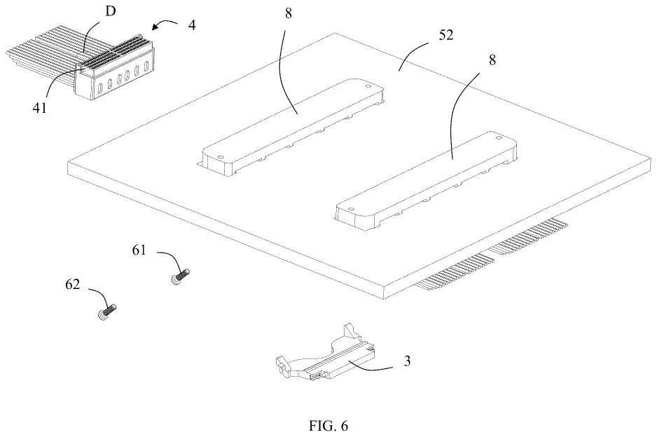

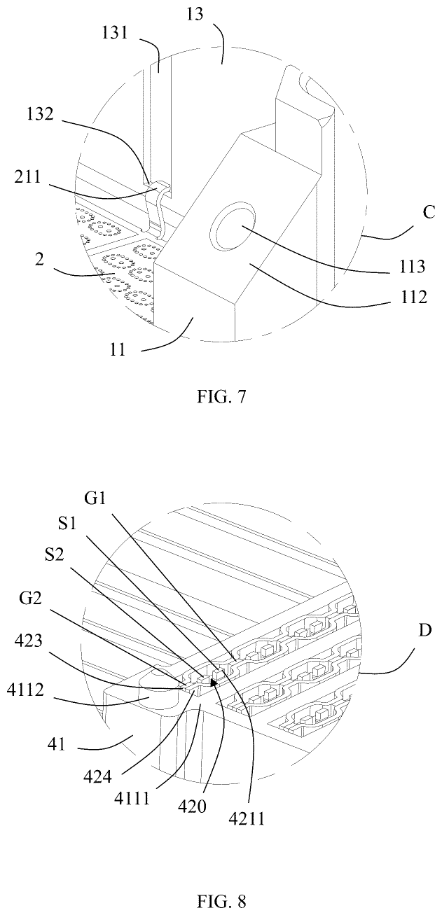

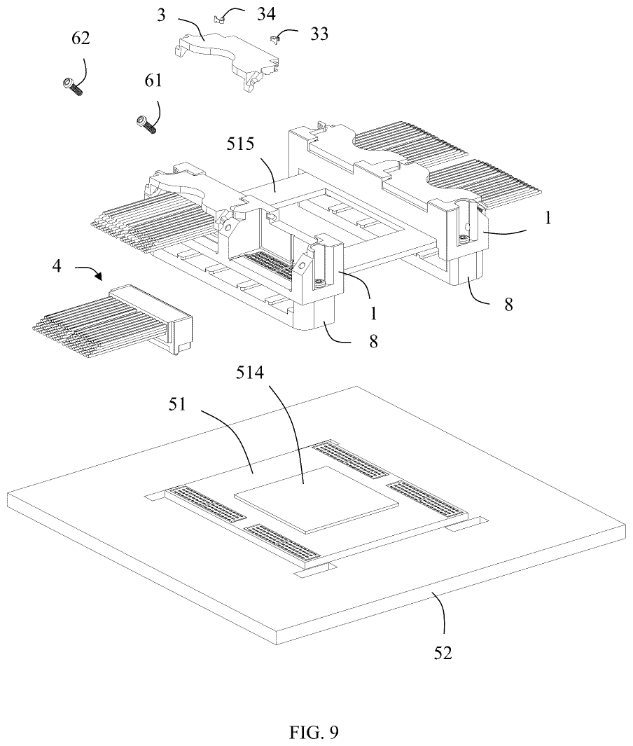

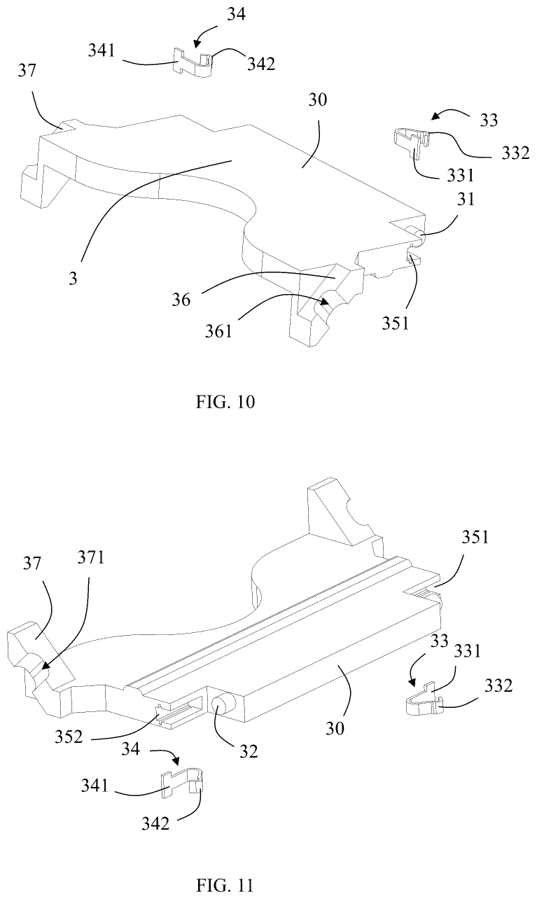

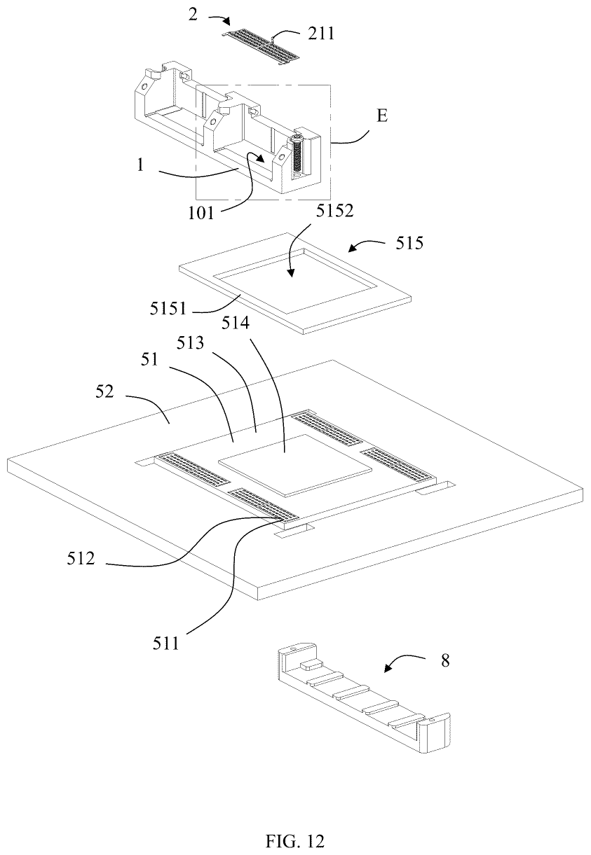

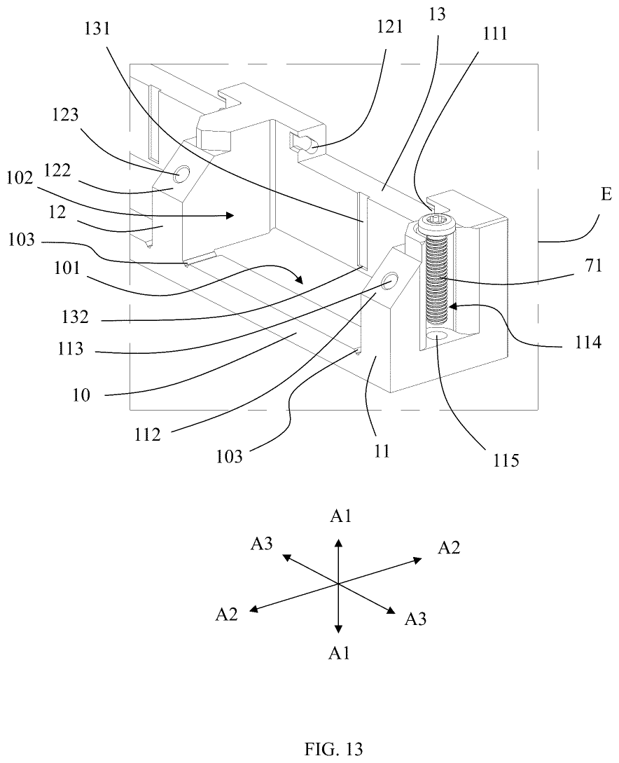

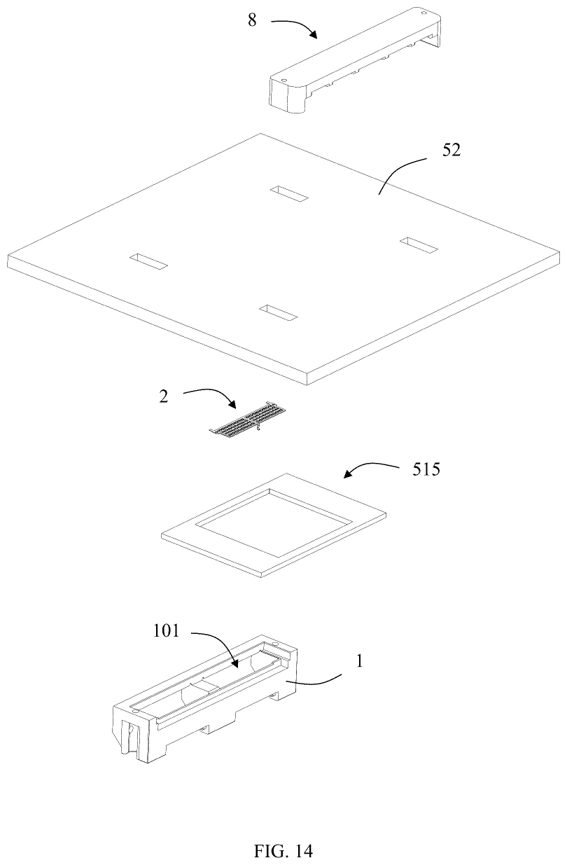

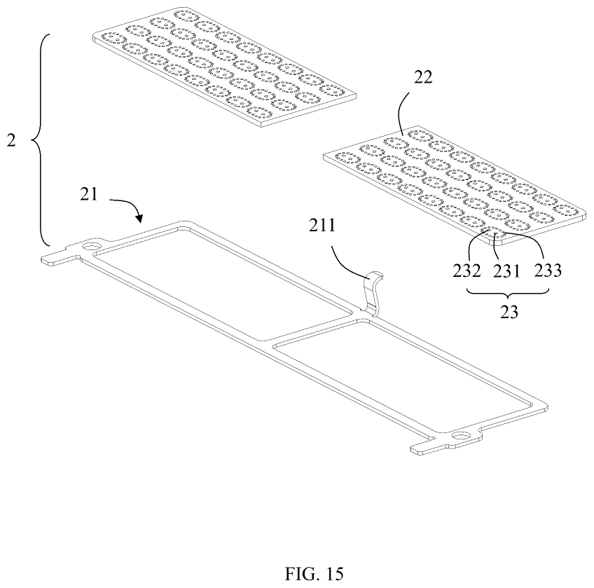

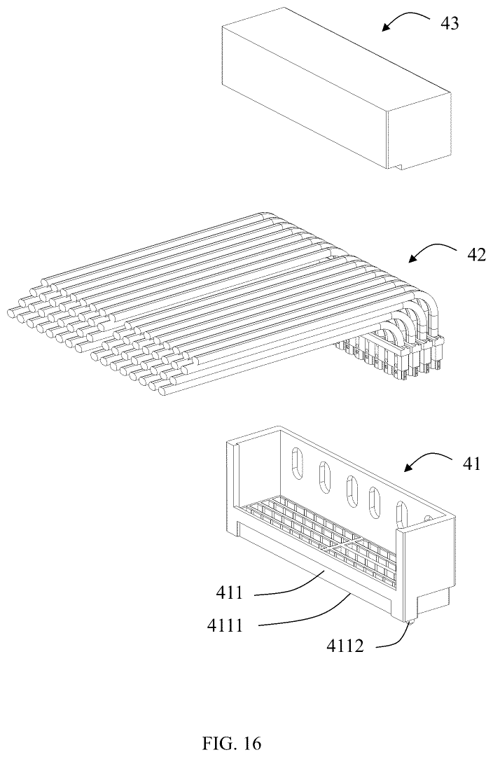

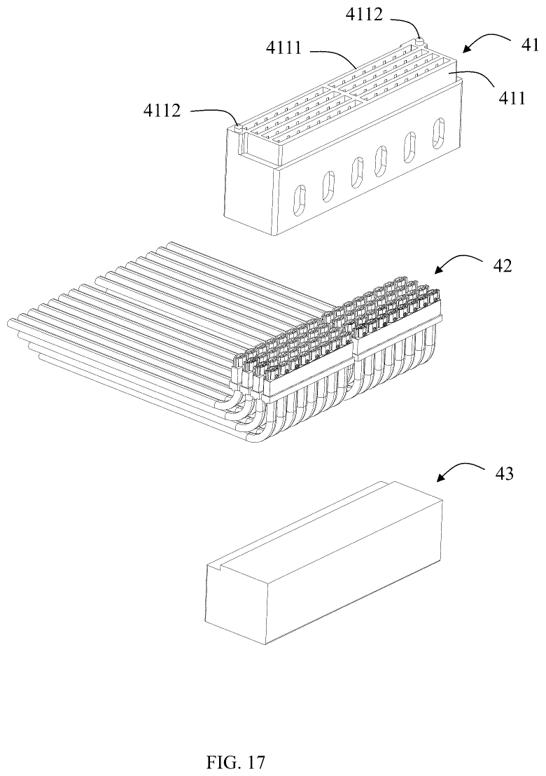

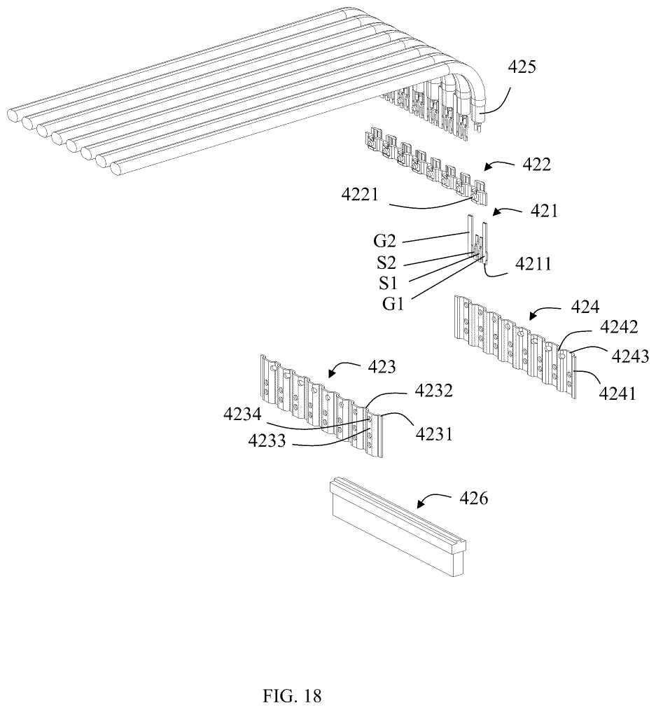

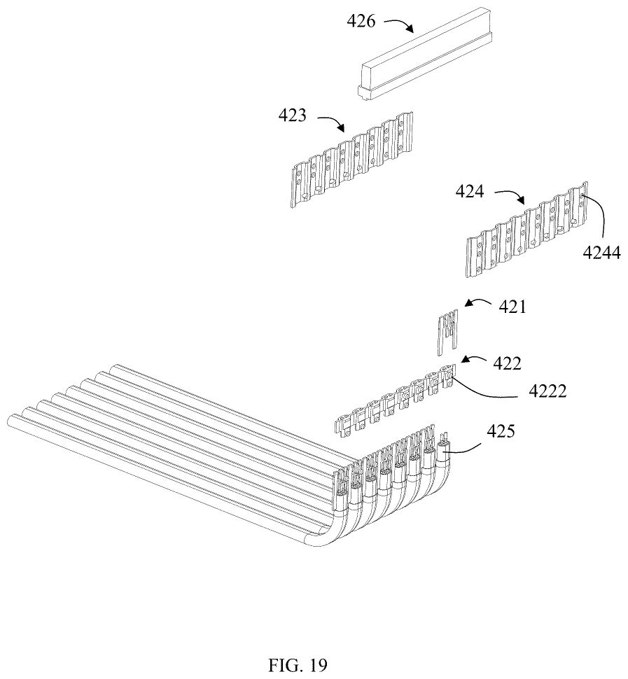

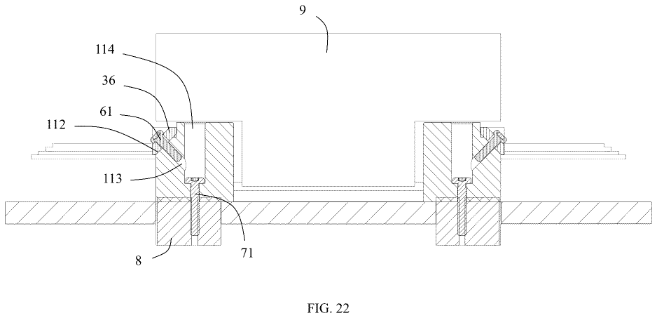

Referring to FIG. 1 to FIG. 22, a first embodiment of the present disclosure discloses a connector assembly, which includes a first circuit board 51, a second circuit board 52 electrically connected to the first circuit board 51, a mounting bracket 1 mounted on the first circuit board 51 and/or the second circuit board 52, a conductive film 2 installed in the mounting bracket 1, a cover 3 rotatably installed on the mounting bracket 1, an electrical connector 4 at least partially installed in the mounting bracket 1, a plurality of fasteners 6 fixing the cover 3 to the mounting bracket 1, and a plurality of fixing components 7 fixing the mounting bracket 1 to the first circuit board 51 and/or the second circuit board 52.

In the illustrated embodiment of the disclosure, the first circuit board 51 is stacked on the second circuit board 52 to be electrically connected to the second circuit board 52. The first circuit board 51 includes a plurality of conductive elements. In the illustrated embodiment of the present disclosure, the plurality of conductive elements are distributed in four areas of the first circuit board 51. In the illustrated embodiment of the present disclosure, for each area, the plurality of conductive elements include a plurality of first signal conductive elements 511 and a plurality of second signal conductive elements 512, in which the adjacent first signal conductive element 511 and second signal conductive element 512 form a differential signal pair. The first signal conductive elements 511 and the second signal conductive elements 512 are exposed to a surface (for example, an upper surface 513) of the first circuit board 51.

Besides, in the illustrated embodiment of the present disclosure, a chip 514 is further mounted on the first circuit board 51. The chip 514 protrudes upwardly beyond the upper surface 513. In order to protect the chip 514, the connector assembly further includes a protective frame 515 mounted on the first circuit board 51. The protective frame 515 is provided with a plurality of protective walls 5151, and an opening 5152 surrounded by the plurality of protective walls 5151 and located in a middle of the protective walls 5151. The chip 514 is received in the opening 5152. It is understandable to those skilled in the art that by providing the protective walls 5151, the chip 514 can be protected and the risk of the chip 514 being damaged due to external forces can be reduced.

In the illustrated embodiment of the present disclosure, a plurality of mounting brackets 1 are provided, wherein each mounting bracket 1 includes a mounting wall 10, a mounting space 101, a receiving space 102 disposed close to the mounting space 101, a first side wall 11 located on one side (for example, a left side) of the receiving space 102, a second side wall 12 located on another side (for example, a right side) of the receiving space 102, and a rear wall 13 located at one end (for example, a rear end) of the receiving space 102. In the illustrated embodiment of the present disclosure, the first side wall 11, the second side wall 12 and the rear wall 13 are integrally extended upwardly from the mounting wall 10.

The mounting wall 10 defines a plurality of recessed positioning grooves 103. In the illustrated embodiment of the present disclosure, each positioning groove 103 is generally V-shaped.

The first side wall 11 includes a first pivot hole 111 adjacent to a top of the rear wall 13, a first inclined surface 112 located at a front end, and a first inclined fastening hole 113 extending through the first inclined surface 112. In addition, the first side wall 11 further includes a first mounting channel 114 located on one side of the first side wall 11 and extending along the first direction A1-A1, and a first mounting through hole 115 communicating with the first mounting channel 114 and extending through the first side wall 11 along the first direction A1-A1. The fixing components 7 include a first fixing component 71 installed from the first mounting channel 114 and at least partially passing through the first mounting through hole 115. In the illustrated embodiment of the present disclosure, the first fixing component 71 is a screw. The connector assembly further includes a mounting block 8 located on a back (for example, a lower surface) of the second circuit board 52. After the first fixing component 71 passes through the first mounting through hole 115, the first fixing component 71 further passes through the second circuit board 52 to be locked in the mounting block 8. With this arrangement, the mounting bracket 1 is fastened together with the first circuit board 51 and the second circuit board 52.

The second side wall 12 includes a second pivot hole 121 adjacent to the top of the rear wall 13, a second inclined surface 122 located at a front end, and a second inclined fastening hole 123 extending through the second inclined surface 122.

The rear wall 13 includes a first positioning mounting groove 131 extending upwardly through the rear wall 13 along the first direction A1-A1 and a first abutment surface 132 located at a bottom of the first positioning mounting groove 131.

The conductive film 2 includes a skeleton 21, an elastomer 22 fixed to the skeleton 21, and a plurality of transfer conductive elements 23 embedded in the elastomer 22. Each transfer conductive element 23 can be a conductive rod made of metal material, or a plurality of discretely distributed conductive particles. The conductive film 2 is at least partially installed in the mounting space 101. The transfer conductive elements 23 are electrically connected to the first circuit board 51. In the illustrated embodiment of the present disclosure, the skeleton 21 of the conductive film 2 includes a first positioning elastic arm 211. The first positioning elastic arm 211 is at least partially installed in the first positioning mounting groove 131 along the first direction A1-A1. A free end of the first positioning elastic arm 211 abuts against the first abutment surface 132 along the first direction A1-A1 to achieve position limiting.

Specifically, in the illustrated embodiment of the present disclosure, the transfer conductive elements 23 include a first signal transfer conductive element 231, a second signal transfer conductive element 232, and a plurality of ground conductive elements 233 discretely surrounding the first signal transfer conductive element 231 and the second signal transfer conductive element 232. In the illustrated embodiment of the present disclosure, the first signal transfer conductive element 231 and the second signal transfer conductive element 232 form a transfer signal differential pair.

The elastomer 22 is able to undergo a certain elastic deformation due to being squeezed along the first direction A1-A1, which facilitates the first signal transfer conductive element 231 and the second signal transfer conductive element 232 to be in contact with the first signal conductive element 511 and the second signal conductive element 512 of the first circuit board 51, respectively. At the same time, it is also beneficial for the transfer conductive elements 23 to be in electrical contact with the electrical connector 4.

The cover 3 is rotatably installed on the mounting bracket 1. The cover 3 is located at one end (for example, an upper end) of the receiving space 102 along the first direction A1-A1. Referring to FIG. 1 to FIG. 3, in the illustrated embodiment of the present disclosure, the connector assembly further includes a shield 9 disposed above the chip 514 and the protective frame 515. The shield 9 extends to both sides and reaches above the cover 3. It is understandable to those skilled in the art that in the presence of the shield 9, the electrical connector 4 cannot be installed into the receiving space 102 along the first direction A1-A1.

In the illustrated embodiment of the present disclosure, the cover 3 is rotatably installed on the mounting bracket 1. The inclination angle of the cover 3 can adjust the opening of the receiving space 102. It is understandable to those skilled in the art that the larger the opening of the receiving space 102 is, the easier it is to install the electrical connector 4 into the receiving space 102 along a second direction A2-A2 (for example, a front-rear direction) parallel to the first circuit board 51. The second direction A2-A2 is substantially perpendicular to the first direction A1-A1. It is understandable to those skilled in the art that the technical term “parallel” used in the present disclosure includes being absolutely parallel to the first circuit board 51, and also includes being slightly inclined to the first circuit board 51.

The cover 3 includes a pressing plate portion 30 configured to press against the electrical connector 4 along the first direction A1-A1, and a first pivoting protrusion 31 and a second pivoting protrusion 32 which protrude from the pressing plate portion 30 toward two sides, respectively, along the third direction A3-A3 (for example, a left-right direction). The third direction A3-A3 is perpendicular to the first direction A1-A1 and the second direction A2-A2. The first pivoting protrusion 31 is received in the first pivot hole 111. The second pivoting protrusion 32 is received in the second pivot hole 121. The first pivoting protrusion 31 and the second pivoting protrusion 32 are aligned along the third direction A3-A3 to form a pivot axis. The cover 3 is rotatable around the pivot axis to adjust an opening size of the receiving space 102.

Preferably, in an embodiment of the present disclosure, the connector assembly further includes at least one elastic element located between the cover 3 and the mounting bracket 1 to exert force on the cover 3 to expand the opening of the receiving space 102.

In the illustrated embodiment of the present disclosure, the elastic element includes a first elastic piece 33 and a second elastic piece 34. The first elastic piece 33 includes a first fixing portion 331 and a first elastic arm 332 extending from the first fixing portion 331. The second elastic piece 34 includes a second fixing portion 341 and a second elastic arm 342 extending from the second fixing portion 341.

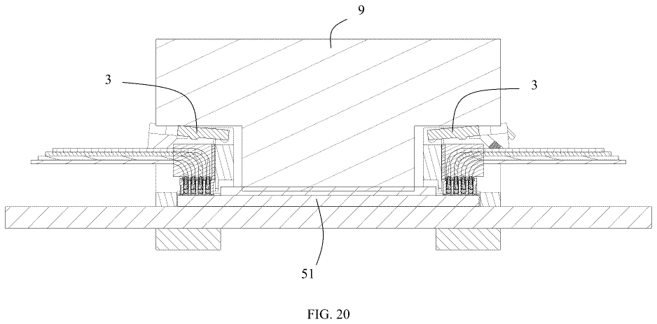

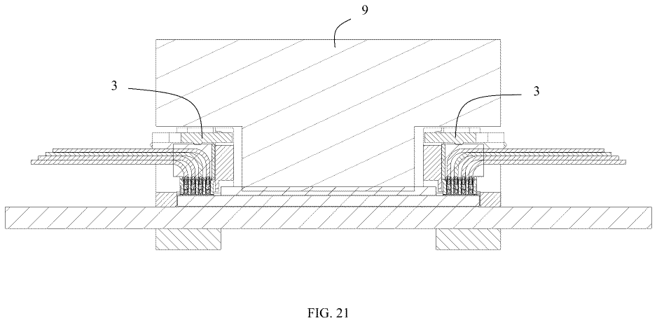

The cover 3 includes a first mounting groove 351 for mounting the first fixing portion 331 and a second mounting groove 352 for mounting the second fixing portion 341. The first elastic arm 332 extends out of the first mounting groove 351 to elastically abut against the mounting bracket 1. The second elastic arm 342 extends out of the second mounting groove 352 to elastically abut against the mounting bracket 1. It is understandable to those skilled in the art that when an external force does not act on the cover 3, the first elastic piece 33 and the second elastic piece 34 can exert a certain force on the cover 3, making the cover 3 in an inclined state (referring to FIG. 20). At this time, the opening of the receiving space 102 is enlarged, which is beneficial to installing the electrical connector 4 along the second direction A2-A2.

Of course, it is understandable to those skilled in the art that the elastic element is not limited to the structure of the first elastic piece 33 and the second elastic piece 34 in the illustrated embodiment of the present disclosure, and may also be of other structures. For example, the elastic element can also be a compression spring (not shown) disposed between the mounting bracket 1 and the cover 3, or any other elastic structure that can exert force on the cover 3 to expand the opening of the receiving space 102. The specific design of the above elastic structure can be understood by those skilled in the art, or those skilled in the art can find solutions in the relevant mechanical field, which will not be described in detail in the present disclosure.

Besides, in the illustrated embodiment of the present disclosure, the cover 3 is provided with a first inclined wall 36, a first inclined mounting hole 361 extending through the first inclined wall 36, a second inclined wall 37, and a second inclined mounting hole 371 extending through the second inclined wall 37. The first inclined mounting hole 361 is aligned with the first inclined fastening hole 113. The second inclined mounting hole 371 is aligned with the second inclined fastening hole 123.

The electrical connector 4 includes an insulating body 41, a plurality of cable modules 42, and a fixing block 43 fixed on the cable modules 42. In one embodiment of the present disclosure, the fixing block 43 is made of insulating material and is over-molded on the cable modules 42 to be integrated as a whole.

In the illustrated embodiment of the present disclosure, the insulating body 41 includes a bottom wall 411 located at a bottom thereof. The bottom wall 411 includes a first mounting surface 4111 and a plurality of positioning posts 4112 protruding downwardly beyond the first mounting surface 4111.

Each cable module 42 includes a plurality of conductive terminals 421, a first insulating block 422 fixed on the conductive terminals 421, a first metal shielding piece 423 installed on one side of the first insulating block 422, a second metal shielding piece 424 installed on another side of the first insulating block 422, a plurality of cables 425 connected to the conductive terminals 421, and a second insulating block 426 molded on the first metal shielding piece 423, the second metal shielding piece 424, the first insulating block 422 and the cables 425.

In the illustrated embodiment of the present disclosure, the conductive terminals 421 include a first signal conductive terminal S1, a second signal conductive terminal S2, a first ground terminal G1 and a second ground terminal G2. The first signal conductive terminal S1 and the second signal conductive terminal S2 form a signal differential pair DP in order to increase the signal transmission rate. The first ground terminal G1 and the second ground terminal G2 are located on two sides of the signal differential pair DP, respectively, to improve the quality of signal transmission. The cables 425 are connected to the first signal conductive terminal S1 and the second signal conductive terminal S2. In the illustrated embodiment of the present disclosure, the width and height of the first ground terminal G1 are respectively greater than the width and height of the first signal conductive terminal S1. The width and height of the first ground terminal G1 are respectively greater than the width and height of the second signal conductive terminal S2. The width and height of the second ground terminal G2 are respectively greater than the width and height of the first signal conductive terminal S1. The width and height of the second ground terminal G2 are respectively greater than the width and height of the second signal conductive terminal S2. Each conductive terminal 421 includes a non-resilient/rigid contact portion 4211. In the illustrated embodiment of the present disclosure, the contact portion 4211 is in a shape of a flat strip.

In the illustrated embodiment of the present disclosure, the first insulating block 422 is molded on the conductive terminals 421 to be integrated as a whole with the conductive terminals 421. The contact portion 4211 of each conductive terminal 421 extends downwardly and protrudes beyond the first insulating block 422. A first protruding post 4221 is provided on one side of the first insulating block 422, and a second protruding post 4222 is provided on another side of the first insulating block 422. The first ground terminal G1 and the second ground terminal G2 both extend upwardly and protrude beyond the first insulating block 422.

In the illustrated embodiment of the present disclosure, the first metal shielding piece 423 is generally wavy-shaped and includes a first abutting portion 4231, a second abutting portion 4232, and a first raised portion 4233 connected between the first abutting portion 4231 and the second abutting portion 4232.

Similarly, the second metal shielding piece 424 is generally wavy-shaped and includes a third abutting portion 4241, a fourth abutting portion 4242, and a second raised portion 4243 connected between the third abutting portion 4241 and the fourth abutting portion 4242. The first raised portion 4233 and the second raised portion 4243 have opposite raised directions. The first raised portion 4233 defines a first positioning hole 4234 that matches the first protruding post 4221. The second raised portion 4243 defines a second positioning hole 4244 that matches the second protruding post 4222.

In the illustrated embodiment of the present disclosure, the first abutting portion 4231 and the third abutting portion 4241 are in contact with two opposite side surfaces of the first ground terminal G1, respectively. The second abutting portion 4232 and the fourth abutting portion 4242 are in contact with two opposite side surfaces of the second ground terminal G2, respectively. The first abutting portion 4231, the first raised portion 4233, the second abutting portion 4232, the second ground terminal G2, the fourth abutting portion 4242, the second raised portion 4243, the third abutting portion 4241 and the first ground terminal G1 together form a shielding cavity 420. The first signal conductive terminal S1 and the second signal conductive terminal S2 are at least partially located in the shielding cavity 420 to improve the quality of signal transmission.

In the illustrated embodiment of the present disclosure, the shielding cavity 420 is exposed to the bottom wall 411. The contact portion 4211 of the first signal conductive terminal S1, the contact portion 4211 of the second signal conductive terminal S2, the contact portion 4211 of the first ground terminal G1, the contact portion 4211 of the second ground terminal G2, the first metal shielding piece 423 and the second metal shielding piece 424 all extend downwardly and protrude beyond the first mounting surface 4111.

In the illustrated embodiment of the present disclosure, the contact portion 4211 of the first signal conductive terminal S1, the contact portion 4211 of the second signal conductive terminal S2, the contact portion 4211 of the first ground terminal G1, and the contact portion 4211 of the second ground terminal G2 are all inelastic structures. When the contact portion 4211 of the first signal conductive terminal S1, the contact portion 4211 of the second signal conductive terminal S2, the contact portion 4211 of the first ground terminal G1, and the contact portion 4211 of the second ground terminal G2 come into contact with the transfer conductive elements 23 of the conductive film 2, the contact mode is hard contact. Of course, it is understandable to those skilled in the art that the contact portion 4211 of the first signal conductive terminal S1, the contact portion 4211 of the second signal conductive terminal S2, the contact portion 4211 of the first ground terminal G1, and the contact portion 4211 of the second ground terminal G2 may also be an elastic structure (for example, an elastic arm). At this time, when the contact portion 4211 of the first signal conductive terminal S1, the contact portion 4211 of the second signal conductive terminal S2, the contact portion 4211 of the first ground terminal G1, and the contact portion 4211 of the second ground terminal G2 come into contact with the transfer conductive elements 23 of the conductive film 2, the contact mode is elastic contact.

In the illustrated embodiment of the present disclosure, the fasteners 6 include a first fastener 61 (for example, a first screw) and a second fastener 62 (for example, a second screw).

The electrical connector 4 is installed in the receiving space 102 along the second direction A2-A2. The positioning posts 4112 are guided and installed into the receiving space 102 along the positioning grooves 103. After the electrical connector 4 is installed in place, the first fastener 61 is passed through the first inclined mounting hole 361 and fastened in the first inclined fastening hole 113. The second fastener 62 is passed through the second inclined mounting hole 371 and fastened in the second inclined fastening hole 123. The first inclined wall 36 of the cover 3 abuts against the first inclined surface 112 of the first side wall 11. At this time, the fasteners 6 fix the cover 3 to the mounting bracket 1 so that the cover 3 presses against the electrical connector 4 downwardly along the first direction A1-A1. The elastomer 22 of the conductive film 2 is clamped between the electrical connector 4 and the first circuit board 51 along the first direction A1-A1. At this time, the contact portion 4211 of the first ground terminal G1 and the contact portion 4211 of the second ground terminal G2 of the electrical connector 4 are both in contact with the ground conductive elements 233 of the conductive film 2. The contact portion 4211 of the first signal conductive terminal S1 and the contact portion 4211 of the second signal conductive terminal S2 of the electrical connector 4 are in contact with the first signal transfer conductive element 231 and the second signal transfer conductive element 232 of the conductive film 2, respectively. At the same time, the first signal transfer conductive element 231 and the second signal transfer conductive element 232 of the conductive film 2 are in contact with the first signal conductive element 511 and the second signal conductive element 512 of the first circuit board 51, respectively. With this arrangement, the conductive terminals 421 of the electrical connector 4 are electrically connected to the first circuit board 51 through the transfer conductive elements 23 of the conductive film 2. It is understandable to those skilled in the art that the technical term “press against” used in the present disclosure is intended to indicate that applying a certain force to the electrical connector 4 through the cover 3 can enable the conductive terminals 421, the first metal shielding piece 423 and the second metal shielding piece 424 of the electrical connector 4 to achieve reliable contact with the transfer conductive elements 23 of the conductive film 2, rather than indicating whether the conductive terminals 421, the first metal shielding piece 423 and the second metal shielding piece 424 of the electrical connector 4 are in elastic or inelastic contact with the transfer conductive elements 23 of the conductive film 2.

The present disclosure also discloses a method of installing the aforementioned connector assembly, which includes:
installing the conductive film 2 in the mounting space 101 of the mounting bracket 1 along the first direction A1-A1;
installing the mounting bracket 1 to the first circuit board 51;
installing the cover 3 on the mounting bracket 1;
installing the electrical connector 4 at least partially into the receiving space 102 of the mounting bracket 1 along the second direction A2-A2 parallel to the first circuit board 51; and
passing the first fastener 61 through the cover 3 and fix it with the mounting bracket 1.

As a result, the cover 3 presses against the electrical connector 4 along the first direction A1-A1, so that the conductive terminals 421 of the electrical connector 4 are electrically connected to the first circuit board 51 through the transfer conductive elements 23.

It is understandable to those skilled in the art that the order of the above steps can be flexibly adjusted as needed, and will not be described in detail in the present disclosure.

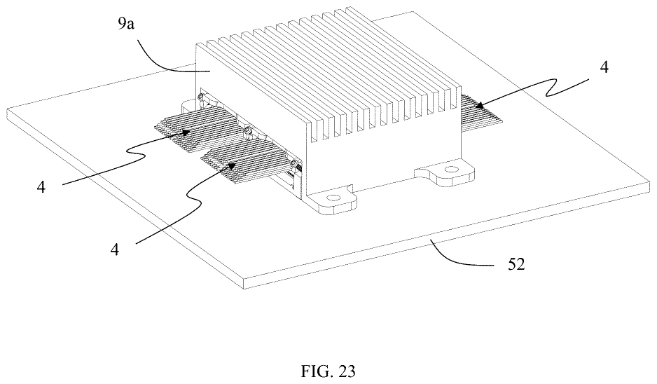

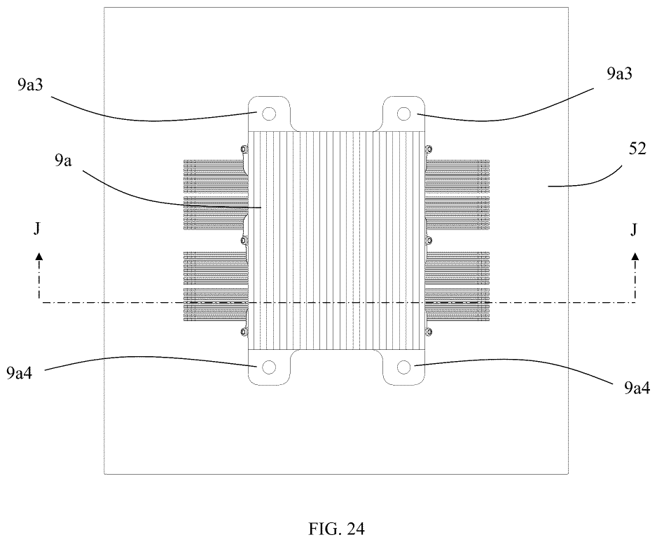

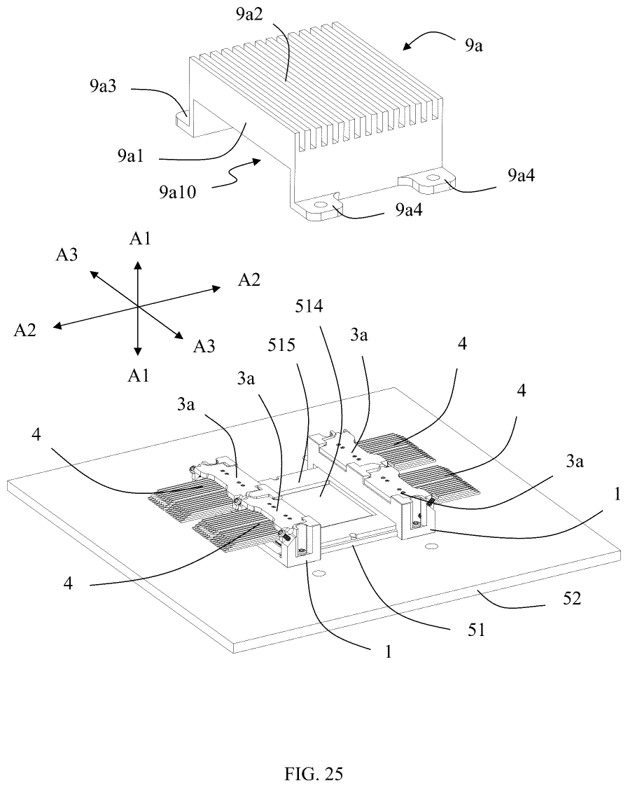

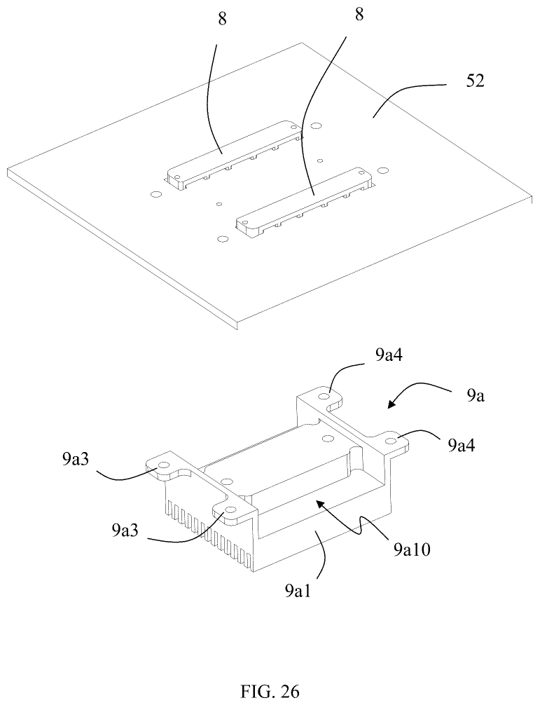

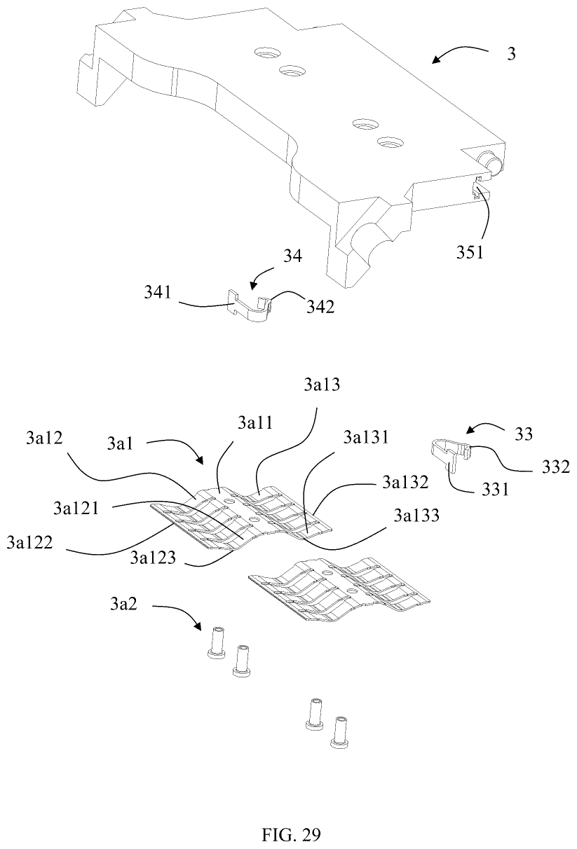

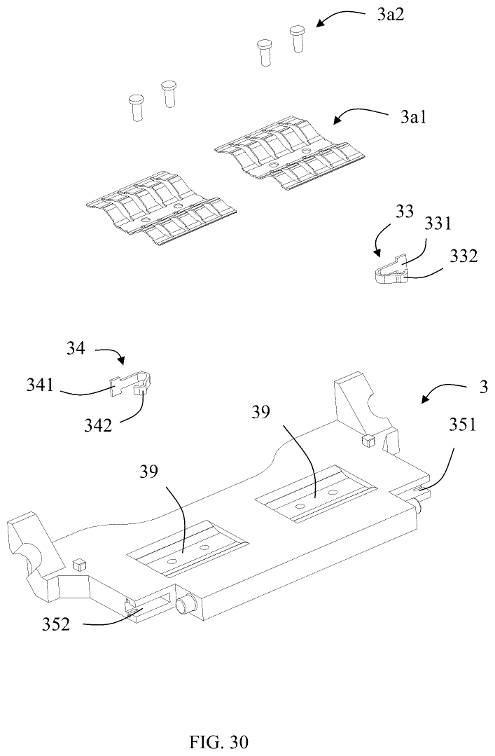

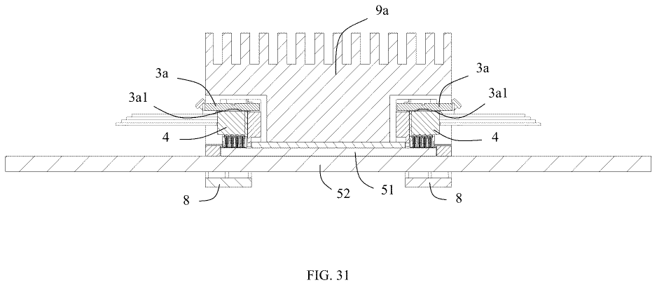

Referring to FIG. 23 to FIG. 31, a second embodiment of the present disclosure discloses a connector assembly, which includes a first circuit board 51, a second circuit board 52 electrically connected to the first circuit board 51, a mounting bracket 1 mounted on the first circuit board 51 and/or the second circuit board 52, a conductive film 2 installed in the mounting bracket 1, a cover assembly 3a rotatably installed on the mounting bracket 1, an electrical connector 4 at least partially installed in the mounting bracket 1, a plurality of fasteners 6 fixing the cover assembly 3a to the mounting bracket 1, and a plurality of fixing components 7 fixing the mounting bracket 1 to the first circuit board 51 and/or the second circuit board 52. The connector assembly in the second embodiment shown in FIG. 23 to FIG. 31 is similar to the connector assembly in the first embodiment shown in FIG. 1 to FIG. 22. The main difference therebetween is that the connector assembly in the second embodiment of the present disclosure includes a heat sink 9a. The heat sink 9a corresponds to the shield 9 in the first embodiment. In addition, the cover assembly 3a of the connector assembly in the second embodiment is different from the cover 3 of the connector assembly in the first embodiment. The other structures of the connector assembly in the second embodiment of the present disclosure are the same as corresponding structures of the connector assembly in the first embodiment, and the same structures will not be described in detail again.

The connector assembly in the second embodiment shown in FIG. 23 to FIG. 31 is similar to the connector assembly in the first embodiment shown in FIG. 1 to FIG. 22. The main difference therebetween is that the connector assembly in the second embodiment of the present disclosure includes a heat sink 9a. The heat sink 9a corresponds to the shield 9 in the first embodiment. In addition, the cover assembly 3a of the connector assembly in the second embodiment is different from the cover 3 of the connector assembly in the first embodiment. The other structures of the connector assembly in the second embodiment of the present disclosure are the same as corresponding structures of the connector assembly in the first embodiment, and the same structures will not be described in detail again.

In the second embodiment of the connector assembly of the present disclosure, the heat sink 9a includes a main body portion 9a1, a plurality of heat dissipation fins 9a2 protruding from the main body portion 9a1, a plurality of first mounting portions 9a3 protruding beyond the main body portion 9a1 to one side along the third direction A3-A3, and a plurality of second mounting portions 9a4 protruding beyond the main body portion 9a1 to another side along the third direction A3-A3. In the illustrated embodiment of the present disclosure, a bottom of the main body portion 9a1 defines an accommodating space 9a10. The accommodating space 9a10 is in communication with the receiving space 102 to form a space for installing the electrical connector 4. In the illustrated embodiment of the present disclosure, the heat dissipation fins 9a2 are integrally formed with the main body portion 9a1. The first mounting portions 9a3 and the second mounting portions 9a4 are also integrally formed with the main body portion 9a1 to improve structural strength. In the second embodiment of the present disclosure, the first mounting portions 9a3 and the second mounting portions 9a4 are configured to be mounted and fixed to the second circuit board 52, thereby fixing the heat sink 9a to the second circuit board 52.

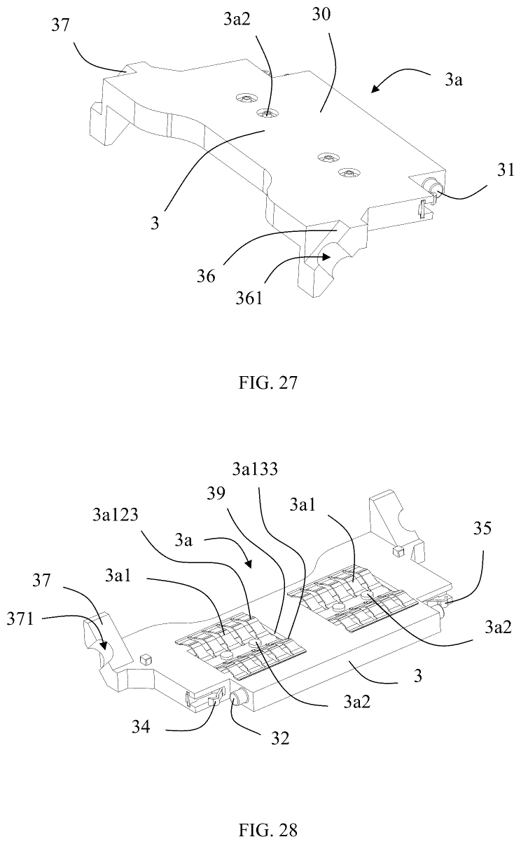

Referring to FIG. 27 to FIG. 31, the cover assembly 3a includes a cover 3, an elastic component 3a1 secured to the cover 3, and a fixing component 3a2 for fixing the elastic component 3a1 to the cover 3. The cover 3 includes a pressing plate portion 30 configured to press against the electrical connector 4 along the first direction A1-A1, and a first pivoting protrusion 31 and a second pivoting protrusion 32 which protrude from the pressing plate portion 30 toward two sides, respectively, along the third direction A3-A3. The first pivoting protrusion 31 is received in the first pivot hole 111. The second pivoting protrusion 32 is received in the second pivot hole 121. The first pivoting protrusion 31 and the second pivoting protrusion 32 are aligned along the third direction A3-A3 to form a pivot axis. The cover 3 is rotatable around the pivot axis to adjust an opening size of the receiving space 102.

Preferably, in an embodiment of the present disclosure, the connector assembly further includes at least one elastic element located between the cover 3 and the mounting bracket 1 to exert force on the cover 3 to expand the opening of the receiving space 102.

In the illustrated embodiment of the present disclosure, the elastic element includes a first elastic piece 33 and a second elastic piece 34. The first elastic piece 33 includes a first fixing portion 331 and a first elastic arm 332 extending from the first fixing portion 331. The second elastic piece 34 includes a second fixing portion 341 and a second elastic arm 342 extending from the second fixing portion 341.

The cover 3 includes a first mounting groove 351 for mounting the first fixing portion 331 and a second mounting groove 352 for mounting the second fixing portion 341. The first elastic arm 332 extends out of the first mounting groove 351 to elastically abut against the mounting bracket 1. The second elastic arm 342 extends out of the second mounting groove 352 to elastically abut against the mounting bracket 1. It is understandable to those skilled in the art that when an external force does not act on the cover 3, the first elastic piece 33 and the second elastic piece 34 can exert a certain force on the cover 3, making the cover 3 in an inclined state. At this time, the opening of the receiving space 102 is enlarged, which is beneficial to installing the electrical connector 4 along the second direction A2-A2.

Of course, it is understandable to those skilled in the art that the elastic element is not limited to the structure of the first elastic piece 33 and the second elastic piece 34 in the illustrated embodiment of the present disclosure, and may also be of other structures. For example, the elastic element can also be a compression spring (not shown) disposed between the mounting bracket 1 and the cover 3, or any other elastic structure that can exert force on the cover 3 to expand the opening of the receiving space 102. The specific design of the above elastic structure can be understood by those skilled in the art, or those skilled in the art can find solutions in the relevant mechanical field, which will not be described in detail in the present disclosure.

Besides, in the illustrated embodiment of the present disclosure, the cover 3 is provided with a first inclined wall 36, a first inclined mounting hole 361 extending through the first inclined wall 36, a second inclined wall 37, and a second inclined mounting hole 371 extending through the second inclined wall 37. The first inclined mounting hole 361 is aligned with the first inclined fastening hole 113. The second inclined mounting hole 371 is aligned with the second inclined fastening hole 123.

A plurality of recessed grooves 39 are provided on an inner surface of the cover 3. Referring to FIG. 27 to FIG. 31, in the second embodiment of the present disclosure, the elastic component 3a1 is a leaf spring, which includes an intermediate portion 3a11, a first extension portion 3a12 extending to one side from the intermediate portion 3a11, and a second extension portion 3a13 extending to another side from the intermediate portion 3a11. In the illustrated embodiment of the present disclosure, the first extension portion 3a12 is provided with a plurality of first abutting spring tabs 3a121 arranged side by side, and a first connecting portion 3a122 connected end portions of the first abutting spring tabs 3a121 together. The first abutting spring tab 3a121 is provided with a first elastic abutting portion 3a123 for elastically abutting against the electrical connector 4. Similarly, the second extension portion 3a13 is provided with a plurality of second abutting spring tabs 3a131 arranged side by side, and a second connecting portion 3a132 connected end portions of the second abutting spring tabs 3a131 together. The second abutting spring tab 3a131 is provided with a second elastic abutting portion 3a133 for elastically abutting against the electrical connector 4. It is understandable to those skilled in the art that by providing the elastic component 3a1 elastically abutting against the electrical connector 4, the extrusion pressure of the cover 3 pressing the electrical connector 4 downwardly along the first direction A1-A1 can be improved. As a result, the conductive terminals 421 of the electrical connector 4 are enabled to achieve reliable electrical conduction with the first circuit board 51 by means of the transfer conductive elements 23 of the conductive film 2. The plurality of first abutting spring tabs 3a121 arranged side by side and the plurality of second abutting spring tabs 3a131 arranged side by side can exert a relatively balanced force on the electrical connector 4 so as to more smoothly press against the electrical connector 4. As a result, the elastic component 3a1 can also more reliably retain the electrical connector 4 in the receiving space 102, thereby reducing contact defects that may be caused by vibration or the like. Of course, it is understandable to those skilled in the art that the elastic component 3a1 is not limited to the leaf spring in the present disclosure, but may also be other structures, such as compression springs, or the like.

In the illustrated embodiment of the present disclosure, the intermediate portion 3a11 is received in the recessed groove 39. The first elastic abutting portions 3a123 and the second elastic abutting portions 3a133 are located outside the recessed groove 39 to abut against the electrical connector 4.

In the illustrated embodiment of the present disclosure, the fixing component 3a2 is a screw or a rivet, which fixes the intermediate portion 3a11 to the inner surface of the cover plate 3.

The second embodiment of the present disclosure also discloses a method of installing the aforementioned connector assembly, which includes:
installing the conductive film 2 in the mounting space 101 of the mounting bracket 1 along the first direction A1-A1;
installing the mounting bracket 1 to the first circuit board 51;
installing the cover assembly 3a on the mounting bracket 1;
installing the heat sink 9a to the second circuit board 52;
installing the electrical connector 4 at least partially into the receiving space 102 of the mounting bracket 1 along the second direction A2-A2 parallel to the first circuit board 51; and
passing the first fastener 61 through the cover 3 and fix it with the mounting bracket 1.

As a result, the cover 3 presses against the electrical connector 4 along the first direction A1-A1, so that the conductive terminals 421 of the electrical connector 4 are electrically connected to the first circuit board 51 through the transfer conductive elements 23.

It is understandable to those skilled in the art that the order of the above steps can be flexibly adjusted as needed, and will not be described in detail in the present disclosure.

Compared with the prior art, the connector assembly of the present disclosure includes the mounting bracket 1, the conductive film 2, the cover 3, the electrical connector 4 and the first fastener 61. The cover 3 is rotatably installed on the mounting bracket 1. The electrical connector 4 is at least partially installed into the receiving space 102 along the second direction A2-A2 parallel to the first circuit board 51. With this arrangement, the connector assembly and the method of installing the connector assembly of the present disclosure can utilize the space in the second direction A2-A2 to install the electrical connector 4 when the space in the first direction A1-A1 is limited, thereby solving the installation problem. In some application scenarios, installing the heat sink 9a on the second circuit board 52 is an operation that customers need to perform. However, since the electrical connectors 4 of the present disclosure are installed into the receiving spaces 102 along lateral directions, they are not affected by the heat sink 9a. Therefore, the customers are able to firstly install the heat sink 9a on the second circuit board 52, and then install the electrical connectors 4, thereby improving the flexibility of the installation.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. A connector assembly, comprising:
a mounting bracket configured to be mounted to a circuit board, and the mounting bracket defining a receiving space;
a cover rotatably assembled to the mounting bracket;
a heat sink disposed on a side of the mounting bracket, and the receiving space being located between the mounting bracket and the heat sink; and
an electrical connector installed into the receiving space along a lateral direction.

2. The connector assembly according to claim 1, wherein the heat sink comprises a main body portion, a plurality of heat dissipation fins protruding from the main body portion, a first mounting portion protruding from one side of the main body portion, and a second mounting portion protruding from another side of the main body portion; the first mounting portion and the second mounting portion are configured to be mounted to the circuit board.

3. The connector assembly according to claim 1, wherein the main body portion defines an accommodating space; the accommodating space is in communication with the receiving space to form a space in which the electrical connector is installed; and the lateral direction is parallel to the circuit board.

4. The connector assembly according to claim 1, further comprising a cover assembly; the cover assembly comprising the cover and an elastic component secured to the cover; and the elastic component being configured to elastically press against the electrical connector.

5. The connector assembly according to claim 4, wherein the elastic component comprises an intermediate portion, a first extension portion extending from one side of the intermediate portion, and a second extension portion extending from another side of the intermediate portion; the first extension portion is provided with a plurality of first abutting spring tabs arranged in parallel; each first abutting spring tab has a first elastic abutting portion to elastically press against the electrical connector; the second extension portion is provided with a plurality of second abutting spring tabs arranged in parallel; and each second abutting spring tab has a second elastic abutting portion to elastically press against the electrical connector.

6. The connector assembly according to claim 5, wherein the first extension portion comprises a first connecting portion connecting end portions of the plurality of first abutting spring tabs; and the second extension portion comprises a second connecting portion connecting end portions of the plurality of second abutting spring tabs.

7. The connector assembly according to claim 5, wherein the cover defines a recessed groove in which the intermediate portion is received; the first elastic abutting portion and the second elastic abutting portion are located outside the recessed groove; and the cover assembly comprises a fixing component to fasten the intermediate portion to the cover.

8. The connector assembly according to claim 1, wherein the circuit board comprises a first circuit board and a second circuit board; the mounting bracket is configured to be mounted on the first circuit board; the mounting bracket defines a mounting space disposed adjacent to the receiving space along a first direction;
the connector assembly further comprises a conductive film; the conductive film comprises an elastomer and a plurality of transfer conductive elements embedded in the elastomer; the conductive film is at least partially installed in the mounting space; the transfer conductive elements are configured to be electrically connected to the first circuit board;
the electrical connector is installed into the receiving space along a second direction perpendicular to the first direction; the electrical connector comprises a plurality of conductive terminals being in contact with the transfer conductive elements; and
the heat sink is configured to be mounted on the second circuit board.

9. The connector assembly according to claim 8, further comprising a first fastener for fixing the cover to the mounting bracket, thereby enabling the cover to press against the electrical connector along the first direction.

10. The connector assembly according to claim 9, wherein the mounting bracket comprises a first side wall located on one side of the receiving space; the first side wall is provided with a first inclined surface and a first inclined fastening hole extending through the first inclined surface;
the cover is provided with a first inclined wall and a first inclined mounting hole extending through the first inclined wall; the first inclined mounting hole is aligned with the first inclined fastening hole;
the first fastener is a first screw which passes through the first inclined mounting hole and is fastened in the first inclined fastening hole.

11. The connector assembly according to claim 10, wherein the mounting bracket comprises a second side wall located on another side of the receiving space; the second side wall is provided with a second inclined surface and a second inclined fastening hole extending through the second inclined surface;
the cover is provided with a second inclined wall and a second inclined mounting hole extending through the second inclined wall; the second inclined mounting hole is aligned with the second inclined fastening hole;
the connector assembly further comprises a second screw which passes through the second inclined mounting hole and is fastened in the second inclined fastening hole.

12. The connector assembly according to claim 10, wherein the first side wall defines a first mounting channel extending along a first direction and a first mounting through hole communicating with the first mounting channel and extending through the first side wall along the first direction; the first mounting through hole is configured to mount a first fixing component which is installed from the first mounting channel and at least partially passes through the first mounting through hole;
the first inclined fastening hole is in communication with the first mounting channel.

13. The connector assembly according to claim 8, wherein the cover comprises a pressing plate portion configured to press against the electrical connector along the first direction, and a first pivoting protrusion and a second pivoting protrusion which protrude from the pressing plate portion toward two sides, respectively, along a third direction; the third direction is perpendicular to the first direction and the second direction;
the mounting bracket comprises a first end wall; the first end wall defines a first pivot hole to receive the first pivoting protrusion and a second pivoting hole to receive the second pivoting protrusion;
the first pivoting protrusion and the second pivoting protrusion are aligned along the third direction to form a pivot axis; the cover is rotatable around the pivot axis to adjust an opening size of the receiving space.

14. The connector assembly according to claim 8, further comprising an elastic element located between the cover and the mounting bracket to exert force on the cover so as to expand an opening of the receiving space;
wherein the elastic element comprises a first elastic piece and a second elastic piece; the first elastic piece comprises a first fixing portion and a first elastic arm extending from the first fixing portion; the second elastic piece comprises a second fixing portion and a second elastic arm extending from the second fixing portion; and
wherein the cover defines a first mounting groove to install the first fixing portion and a second mounting groove to install the second fixing portion; the first elastic arm extends out of the first mounting groove to elastically abut against the mounting bracket; the second elastic arm extends out of the second mounting groove to elastically abut against the mounting bracket.

15. The connector assembly according to claim 8, wherein the electrical connector comprises an insulating body; the plurality of conductive terminals are at least partially mounted to the insulating body;
the insulating body is provided with a mounting surface and a positioning post protruding beyond the mounting surface along the first direction;
the mounting bracket defines a recessed positioning groove in which the positioning post is installed along the second direction.

16. The connector assembly according to claim 8, wherein the conductive film comprises a skeleton to which the elastomer is fixed; the skeleton comprises a first positioning elastic arm; the mounting bracket comprises a first positioning mounting groove extending along the first direction and a first abutment surface located at a bottom of the first positioning mounting groove; the first positioning elastic arm is at least partially installed in the first positioning mounting groove along the first direction; a free end of the first positioning elastic arm abuts against the first abutment surface along the first direction.

17. The connector assembly according to claim 8, wherein each conductive terminal comprises a non-resilient contact portion which abuts against a corresponding transfer conductive element along the first direction.

18. The connector assembly according to claim 17, wherein the plurality of conductive terminals comprise a first signal conductive terminal, a second signal conductive terminal, a first ground terminal disposed on one side of the first signal conductive terminal and the second signal conductive terminal, and a second ground terminal disposed on another side of the first signal conductive terminal and the second signal conductive terminal;
the electrical connector comprises a first insulating block molded on the first signal conductive terminal, the second signal conductive terminal, the first ground terminal and the second ground terminal;
the electrical connector further comprises a first metal shielding piece installed on one side of the first insulating block and a second metal shielding piece installed on another side of the first insulating block; the first metal shielding piece is in contact with one side of the first ground terminal and one side of the second ground terminal; the second metal shielding piece is in contact with another side of the first ground terminal and another side of the second ground terminal.

19. The connector assembly according to claim 8, wherein the first circuit board comprises a plurality of conductive elements; one end of the transfer conductive element is in contact with a corresponding conductive element, and another end of the transfer conductive element is in contact with a corresponding conductive terminal;
wherein a chip is further mounted on the first circuit board; and
wherein the connector assembly comprises a protective frame mounted on the first circuit board; the protective frame comprises an opening in which the chip is disposed and a plurality of protective walls surrounding the opening to protect the chip.

20. A method of installing a connector assembly, the connector assembly comprising:
a mounting bracket defining a mounting space and a receiving space disposed adjacent to the mounting space along a first direction;
a conductive film comprising an elastomer and a plurality of transfer conductive elements secured in the elastomer; the transfer conductive elements being configured to be electrically connected to a first circuit board;
a cover rotatably assembled to the mounting bracket; the cover being located at one end of the receiving space along the first direction;
a heat sink disposed on a side of the mounting bracket, and the receiving space being located between the mounting bracket and the heat sink;
an electrical connector at least partially installed in the receiving space along a second direction perpendicular to the first direction; the electrical connector comprising a plurality of conductive terminals which are in contact with the transfer conductive elements; and
a first fastener fixing the cover to the mounting bracket so that the cover presses against the electrical connector along the first direction;
the method comprising:
installing the conductive film in the mounting space of the mounting bracket along the first direction;
installing the mounting bracket to the first circuit board or a second circuit board;
installing the cover to the mounting bracket;
installing the heat sink to the second circuit board;
installing the electrical connector at least partially into the receiving space of the mounting bracket along the second direction substantially parallel to the first circuit board; and
passing the first fastener through the cover and fixing the first fastener to the mounting bracket; the cover pressing against the electrical connector along the first direction, so that the plurality of conductive terminals of the electrical connector are electrically connected to the first circuit board through the transfer conductive elements.
